(19) United States
(12) Patent Application Publication
(10) Pub. No.: US 2018/0181624 A1
(43) Pub. Date: Jun. 28, 2018

(54) Model-based generation of synthetical database statistics

(71) Applicant: Friedrich-Schiller-Universitaet Jena, Jena (DE)

(72) Inventor: Christoph Koch, Nuernberg (DE)

(21) Appl. No.: 15/850,775

(22) Filed: Dec. 21, 2017

(30) Foreign Application Priority Data
Dec. 23, 2016 (DE) 102016015663.5

(51) Int. Cl. G06F 17/30; G06F 17/18; G06F 8/10

(52) U.S. Cl. CPC G06F 17/30536; G06F 8/10; G06F 17/18

(57) ABSTRACT

The object of the present invention was to be able to determine predictions as to database performance in a user-friendly manner with little effort at an early stage in the development process. With the help of said predictions, weaknesses in the database design and the database accesses that have been implemented are intended to be able to be effectively detected and, where relevant, corrected, before potentially serious performance problems result from these weaknesses at a later point in time. The expensive generation of (test) data is intended to be dispensed in this procedure.

In order to achieve the object, the present invention describes a method for generating synthetic database statistics on the basis of existing and suitably formalized application knowledge—the PIs. Building on these statistics, explain mechanisms can then be used for lightweight and efficient prediction of the database performance. The following invention describes which PIs are necessary for statistics generation, and how these PIs can be specified within established (UML) modeling tools. The invention furthermore concretizes the individual steps that are necessary for the generation of synthetic statistics. Finally, using the example of the DBMS IBM DB2 for z/OS, it describes an example of how the generation of synthetic statistics can be implemented, and what quality synthetic statistics have in comparison with “real” ones.

Continuous measures for ensuring the quality of a high performance are a central component of agile software and database development. In the sphere of relational database management systems (DBMS), the explain mechanisms established for the execution plan analysis of SQL statements are above all of significance. These can give estimates and predictions of the expected performance for handling SQL statements on the basis of statistics regarding the data stored in the database. Particularly for (new) database applications or application modules without existing, representative data stocks, no statistics thus normally exist. The present invention addresses this problem, and presents an approach to being able nevertheless to use the explain mechanisms for quality assurance even without the expensive generation of (test) data.

The development of modern (database) applications finds itself increasingly confronted with rising requirements and at the same time with reduced available resources. This dichotomy requires efficient processes, from the analysis through to the release of an application. Agile software development attempts to meet this objective. The methods used here are aimed at achieving fast results in the form of executable application components with the least possible effort. This gives rise to a great challenge for the continuous quality assurance of these software modules.

While automated tests to ensure functional correctness are usually successful, early quality assurance of non-functional aspects, such as the database performance that is the focus of the present invention, can only be achieved on the module level with great difficulty. Performance is primarily only examined, through load tests, after all the application modules have been completed. The representative data stocks required for this are however not (yet) available in particular for (new) database applications with data that is new or whose characteristics have changed, and can only be generated with considerable effort through special tools.

Experience shows that performance bottlenecks can often be traced back to weaknesses in the early conceptual design. Problems that are not recognized until a late stage in development typical for load tests can only be corrected through the intensive use of resources. For that reason it is rather more lightweight methods such as the use of explain mechanisms that are suitable for performance analysis in the database sector. These, however, require representative information about the stored data—so-called database statistics—whose preparation by the DBMS normally also requires stored data stocks, and thereby nullifies the most important advantage of the explain mechanisms over load tests.

At the present time, no concepts comparable to the present invention exist for enabling efficient predictions of database performance in a manner that is both simple and practicable. It is true that a large number of (scientific) approaches do exist, as are mentioned, for example, in Koch, Christoph, “Modellbasierte Generierung synthetischer Datenbankstatistiken” [Model-based generation of synthetic database statistics], Datenbank-Spektrum, 16(1):49-65, 2016. These are, however, either excessively simplifying, so that they are not suitable for representative performance predictions, or else are too little suited to practice as a result of additional tools or systems that are required.

Artificially (or synthetically) generated statistics are, apart from the present invention, also a part of international patent application WO2011145116A2. Said application describes a method in which statistics are first transferred out of a production environment into a test environment. From there, they can then be deliberately manipulated by the user, so that, similarly to the case in the present invention, efficient explain analyses can be carried out on the basis of synthetic statistics. Since the statistical manipulation is to be performed directly by the user in patent application WO2011145116A2, said user must themselves know or estimate all the details and formats of the DBMS-specific “physical” statistics (storage) in addition to logical application knowledge. In practice, however, this is impossible, or only possible with considerable effort and database expertise. The approach described in the present invention therefore abstracts relevant statistical information relating to performance indicators (PIs).

In accordance with the explanations above, it follows that the object is to be able to determine predictions as to database performance in a user-friendly manner with little effort at an early stage in the development process. With the help of said predictions, weaknesses in the database design and the database accesses that have been implemented are intended to be able to be effectively detected and, where relevant, corrected, before potentially serious performance problems result from these weaknesses at a later point in time. The expensive generation of (test) data is intended to be dispensed with in this procedure.

In order to achieve the object, the present invention describes a method for generating synthetic database statistics on the basis of existing and suitably formalized application knowledge—the PIs. Building on these statistics, explain mechanisms can then be used for lightweight and efficient prediction of the database performance. The following invention describes which PIs are necessary for statistics generation, and how these PIs can be specified within established (UML) modeling tools. The invention furthermore concretizes the individual steps that are necessary for the generation of synthetic statistics. Finally, using the example of the DBMS IBM DB2 for z/OS, it explains an example of how the generation of synthetic statistics can be implemented, and what quality synthetic statistics have in comparison with “real” ones.

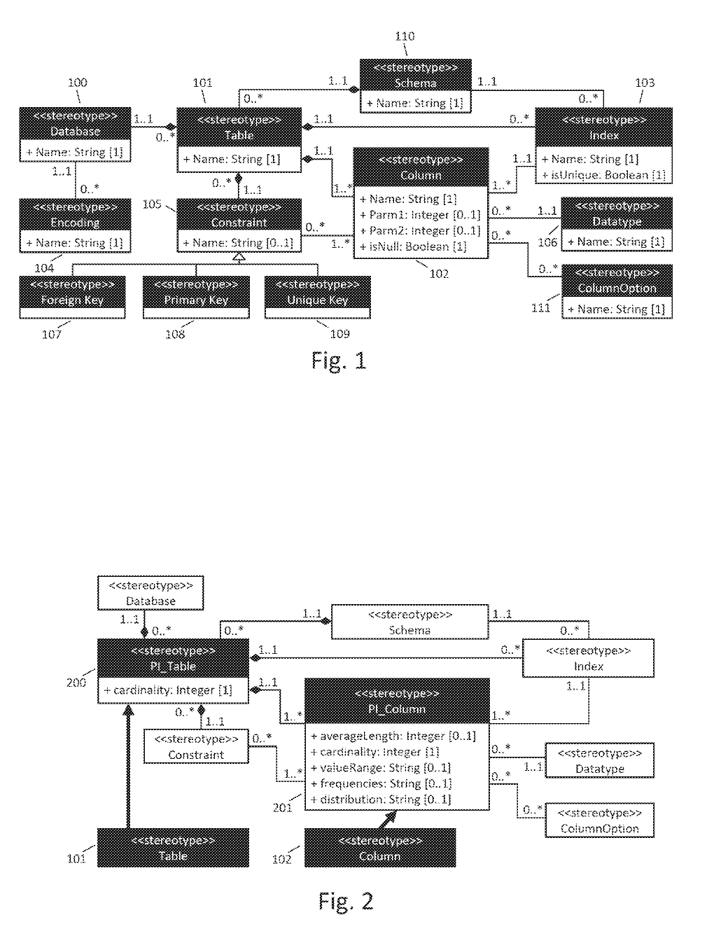

FIG. 1 shows a UML meta-model for data modeling, as is typical in practice;

FIG. 2 illustrates a UML profile for performance indicator modeling based on FIG. 1;

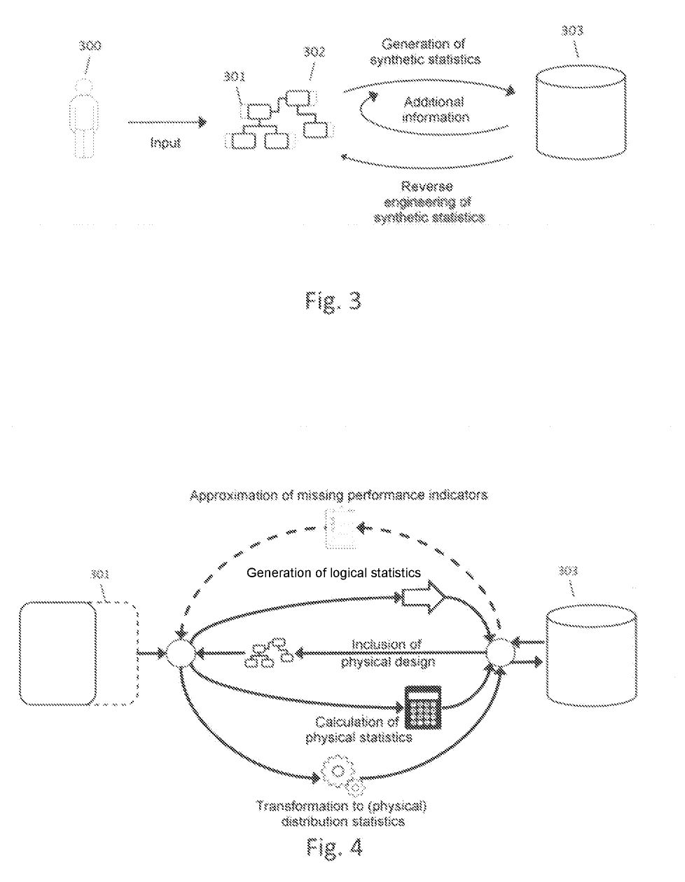

FIG. 3 shows the processes taking place in association with synthetic statistics on an abstracted level;

FIG. 4 illustrates in detail the process of generating synthetic database statistics;

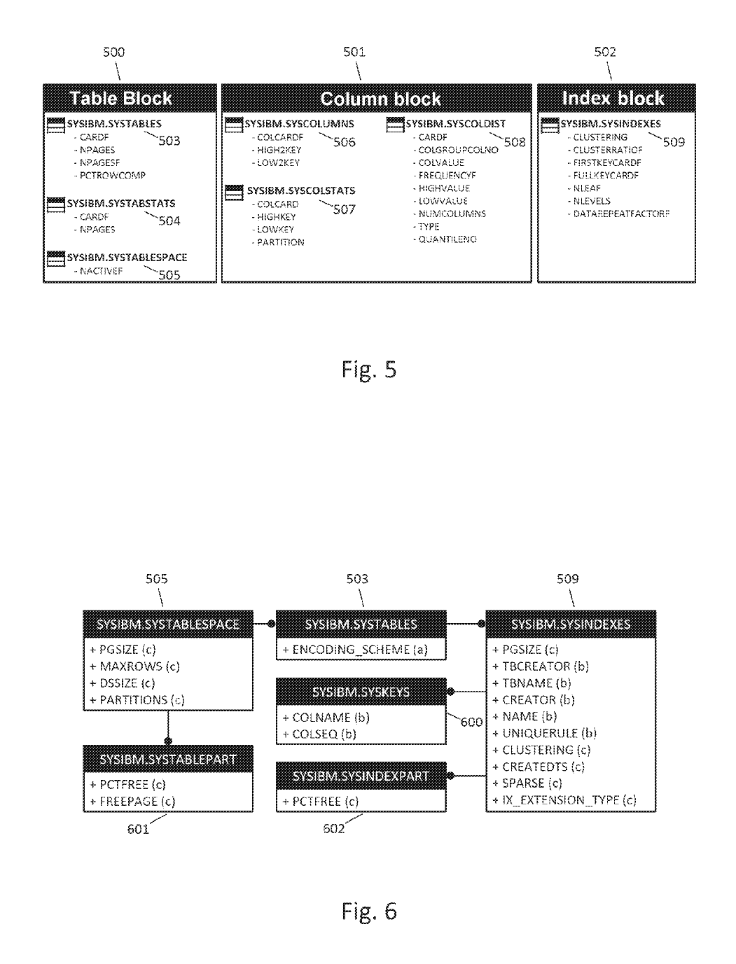

FIG. 5 provides an overview of the database statistics in DB2 relevant to execution plans;

FIG. 6 shows which additional information is necessary from the DB2 catalog for the generation of synthetic database statistics;

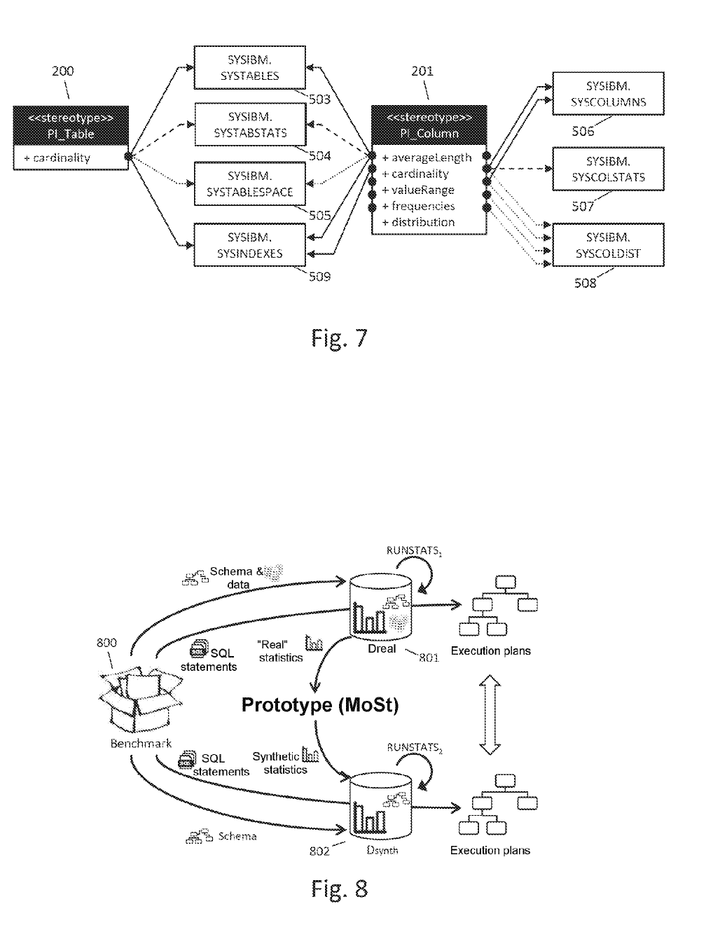

FIG. 7 summarizes the effect of the individual performance indicators on the “statistics tables” in DB2;

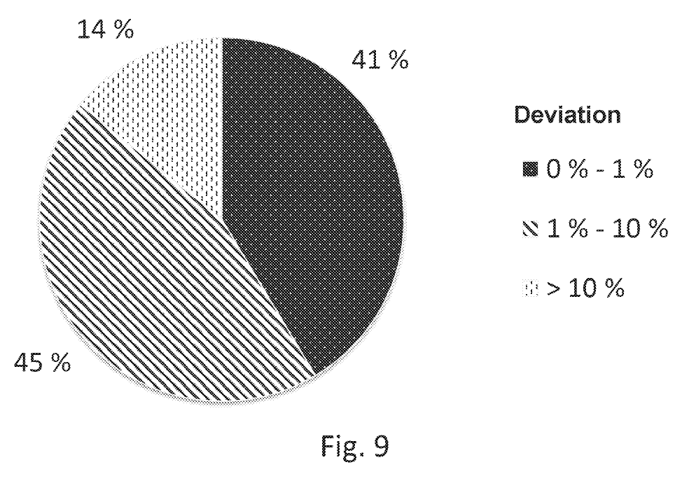

FIG. 8 illustrates the procedure through which the generation of synthetic statistics, and thereby the MoSt prototype, was evaluated;

FIG. 9 gives a visual indication of the results of evaluation performed, and thus reflects the quality of the synthetic statistics.

PIs form the starting point for the generation of synthetic database statistics. They comprise information about data stored or to be stored in the database. PIs usually arise as early as during the requirements analysis of a database application, but until now have not been formalized by any standardized method. To change this, the current invention provides for a formalization of PIs in the data model. Typically, data modeling is realized in the UML language. This has the advantage of being able to prepare and maintain data models together with application models within a tool environment. The PI modeling is therefore also based on a UML modeling.

Based on the paradigms of model-driven architecture and earlier architecture proposals, a distinction is fundamentally made in data modeling, depending on the level of abstraction, between conceptual, logical and physical data modeling. This distinction is not, however, important for the present invention, and therefore only data models in the sense of physical data modeling will be discussed. Physical data modeling varies greatly in practice in its level of detailing, depending on the approach or tool. Scientific approaches usually describe very compact models, whereas the meta-models of data modeling tools established in practice comprise very detailed information. In terms of the level of detailing, the UML (initial) meta-model used here for data modeling is to be classified in between these.

FIG. 1 represents the meta-model used for data modeling in a simplified form. In essence it comprises tables 101, columns 102 and indexes 103, as well as stereotypes relating to these for schemas 110, databases 100, character encoding 104, constraints 105 (primary key 108, unique key 109 and foreign key 107), data types 106 and column options 111. While almost all objects have only one name, supplementary information regarding uniqueness definition (isUnique) is provided for indexes and length parameterizations (Parm1 and Parm2), as well as an optionality identifier (isNull), are provided for columns.

In order to be able to generate representative database statistics on the basis of PIs, PIs must, analogously to statistics, contain information regarding the quantity and distribution of the data stored or to be stored in the database. In terms, in particular, of the necessary granularity of the information on data distribution, two extremes however emerge—simple PIs that are as compact as possible in contrast to detail-rich PIs that are as meaningful as possible.

Agile software development pursues the goal of dismantling complexity, and of keeping processes and methods as simple as possible according to the KISS principle (“Keep It Simple, Silly!”) The recording of PIs should therefore also be kept simple and “dumb”, in order to achieve the greatest possible acceptance for the specification on the part of the architects and designers. On the other hand, it is also true that the more detail PIs are recorded with, the more representative are the synthetic statistics that can be generated on their basis.

To resolve this conflict, the invention provides a compromise between both extremes, so that PIs are only formalized to the degree described below. For a table 101, the cardinality, i.e. the (expected) number of stored tuples, is to be noted. PIs for columns 102 are also a cardinality in the sense of the number of different values within the column as well as an average length, a (discrete or continuous) value range, single value probabilities and a form of distribution. With the exception of the cardinality, all other PIs are optional for the reasons of simplicity and acceptance already mentioned. Further possible PIs on correlations, a dynamic related to the data growth or similar aspects were in the past deliberately neglected in the same context. For the majority of the performance problems that can be covered by explain mechanisms they have no added value, or only a very small one that does not justify a more complex PI specification.

As already explained, data modeling is based largely on the UML modeling language. With the introduction of UML 2.0 in 2005, a flexible option was integrated into the language specification in the form of the UML profile mechanism, through which option the UML meta-model can be extended with its own stereotypes. The advantage of this is that the standard UML language scope can be extended with domain-specific language aspects by means of profiles, without losing the standard conformity and thereby also the tool compatibility and interoperability involved in many cases.

The meta-model illustrated in FIG. 2 for modeling PIs also makes use of the UML profile mechanism and its advantages, and said meta-model is thus seamlessly integrated into existing modeling infrastructures. Two self-defined stereotypes, PI_Table 200 and PI_Column 201, which are derived from the existing stereotypes Table 101 and Column 102, supplemented by the PIs, are provided by said meta-model for the recording of PIs. In their relationships to other stereotypes, PI_Table 200 and PI_Column 201 are integrated analogously to their base-stereotypes in the meta-model already known from FIG. 1. The variant described in this way is, however, only one option for the modeling of PIs. An integration into other meta-models differing from FIG. 1 could also be realized in an analogous manner. In the further explanations, the naming of concrete PIs is performed on the basis of their recording in the UML profile, so that for example PI Table.cardinality refers to the PI of the cardinality for a table 200.

Explain mechanisms used for quality assurance require, as explained above, representative database statistics in order to be able to deliver qualified statements about the expected costs (DBMS cost in CPU and I/O time) for the execution of SQL statements. Since statistics can normally only be prepared on the basis of available data from the DBMS, the expensive generation of suitable test data would be necessary for predictions of the SQL performance of new database applications or new database application modules. This expense can be saved through the concept of synthetic statistics.

The method is based on PIs, and is illustrated in FIG. 3. After PIs 301 have been defined in the data model 302 by the designer/architect 300, synthetic statistics can be generated in a target DBMS 303 on the basis of said PIs with the help of information from the DBMS. It is, conversely, also possible to obtain PIs through reverse engineering on the basis of statistics present in the DBMS 303, to then manipulate them and to synthesize them in turn. The processes of the generation and the reverse engineering are additionally described in more detail in terms of function and application purpose.

The generation of synthetic statistics is based largely on PIs 301, and is strongly system-dependent due to the proprietary format in which statistical data are stored (in tabular form) in each DBMS 303. Specific explanations will therefore at first be omitted, and reference is made to the later explanations in respect of DB2 for z/OS. Moreover the generation of synthetic statistics is, however, also possible in principle for all other relational DBMS 303 with tabular statistical storage. Independently of the DBMS 303, the generation of synthetic statistics generally yields various partial aspects illustrated in FIG. 4, which are explained below in more detail.

The generation of “logical” database statistics relating, for example, to the cardinality of a table 200 is easily possible. These can mostly be adopted directly from the PIs 301.

In order to be able to generate “physical” database statistics, such as for example the number of database pages necessary per table 200, a suitable approximation on the basis of the PIs 301 is necessary. The mathematical specifications made available by the DBMS manufacturers for estimating the required memory capacity in the design of a database are suitable for this purpose. These only require the “logical” information described by PIs 301 as well as purely “static” characteristic figures relating to the physical database scheme, such as for example the page size used, readable from the object definition of tables 101, columns 102 and indexes 103, as an input. All the inputs are thus known, and the (estimated) calculation of the rather quantity-oriented “physical” statistics previously considered is in this way possible.

“Physical” statistics should also be taken as referring to statistics that are not quantity-oriented relating to specific DBMS details such as the internal storage of information on data distribution (e.g. in the form of histograms). The concepts underlying them are an important element of the procedures for recording statistics, and are in this connection extensively documented by the DBMS manufacturers in a publicly available manner. With these preconditions, it is also possible to approximate statistics on data distribution synthetically, and thus to generate internal structures such as, for example, histograms artificially. This will be illustrated later by way of example for histograms in DB2 for z/OS.

As already described, for reasons of acceptance, some PIs 301 are optional information which can sometimes be missing in the data model. These must be appropriately approximated for the generation of statistics. They includes the average length, the value range, the distribution and the individual value probabilities of a column 201. Of these it is possible, for example in the case of data types of fixed length, to determine the (missing) average length thereof exactly on the basis of rules. Similarly, however, missing PIs 301 could also complement each other. For example, on the basis of a plurality of given individual value probabilities, at least an approximate value range can be determined, in that the smallest value is assumed as the lower bound and the largest value of the individual value probabilities as the upper bound. All the approximations, regardless of whether they are based on DBMS-specific information or on other PIs 301, can be made using purely “static” information about DBMS internals, without DBMS access.

In contrast with the previously described approximation of missing PIs 301 on the basis of “static” DBMS benchmark data, it can also be necessary to read concrete properties of objects from the DB catalog 303, and to make use of these in the generation of synthetic statistics.

This is particularly necessary if the data model is (still) incomplete at the time of observation. To generate statistics on columns 201 of data type string, inter alia, information about the character encoding used, e.g. Latin1, UTF-8, UTF-16, etc. is necessary. In a manner dependent thereon, values in PIs 301 are to be converted before synthetic statistics such as, for example, histograms can be generated. If, therefore, the information on character encoding is missing, it must be read from the DB catalog 303.

The reasons here for incomplete data models are diverse. Whereas, as outlined above, missing information relating, for example, to the character encoding can usually be attributed to a lack of care, other information can also be missing from the data model without anyone being to blame. This is, for example, the case when objects are created implicitly by the DBMS 303 without a CREATE instruction for these objects having been executed explicitly by the database administrator. This is, for example, most often the case for indexes 103, which, unless they have been explicitly defined, are in almost all relational DBMS 303, depending on their configuration, created implicitly by default by the DBMS 303 for the support of a primary or unique constraint when it is defined. Indexes 103 of this sort are therefore sometimes not registered in the data model, and must be determined on the basis of the physical design in the DBMS 303 for the generation of synthetic statistics.

Reference should finally be made to the scope of the meta-model used as a cause for the inclusion of catalog information from the DBMS. As explained above, data modeling is carried out with differing granularity, depending on the approach or tool. It is therefore possible that information necessary for the generation of statistics, such as for example the “static” page size mentioned at the outset, cannot and should not be modeled through the meta-model employed at all. Inasmuch, however, as this information is of significance for the generation of synthetic statistics, it must necessarily be read from the database.

The reverse engineering of PIs 301 refers to the reading of PI-relevant database statistics from the DBMS 303, and their extraction to form PIs 301 in the data model. It is largely intended to simplify the work of the specification of the PIs 301, and thus also to increase the acceptance of the method by designers/architects 300. To that extent it is possible, on the basis of data that were prepared for functional tests or which originate (anonymized) from earlier product versions, for various PIs 301 to be preset. In the best case then only the quantity-oriented PIs 301—the cardinality of a table 200 and the cardinality of column 201—would have to be appropriately scaled, without first having manually to add all the PIs 301, such as the value range of a column 201, before a generation.

Compared with the generation of synthetic statistics, the reverse engineering thereof to form PIs 301 is also heavily DBMS-specific. In terms of the complexity of both processes, this analogy does not, however, carry forward. As described, “physical” magnitudes such as, for example, the number of database pages necessary for storage are also calculated in the generation using mathematical approximations from compact “logical” information such as, for example, the cardinality of a table 200. In the reverse engineering of PIs 301, on the other hand, it is sufficient, putting it simply, only to read out the “logical” database statistics and to place them appropriately in the data model as a PI 301.

The only exception to this is the reverse engineering of the column PI of the distribution. It can only be determined on the basis of methods such as, for example, the maximum likelihood method, whose application is not intended to be an object of the invention. It is just worth emphasizing the fact that such methods always analyze real, existing data, which, while they do exist for the reverse engineering scenario, nevertheless would first have to be read, with a lot of effort, out of the DBMS 303. For the MoSt prototype implementation for DB2 for z/OS described below, the implementation of the reverse engineering of the PI 301 of the distribution is therefore omitted.

The MoSt (model-based statistics generator) application example is described below for the method described above. MoSt is a prototype for the generation of synthetic database statistics for DB2 for z/OS, referred to below as DB2, implemented in Java on the basis of the MID Innovator modeling platform. Both systems each offer the necessary functionalities for the model-based generation of synthetic statistics. This means that the Innovator supports the “UML 2.0” specification, and DB2 stores database statistics in (largely) manipulable tables. Just as a realization of MoSt on the basis of a different “UML 2.0” tool would be conceivable, the prototype could fundamentally be implemented also for any other DBMS 303 with tabular statistics storage.

Analogously to the conception of the PIs 301 used, a handling as simple as possible for the later users in the form of designers/architects 300, along with the associated target of high acceptance, was the focus during the development of MoSt. MoSt was therefore intended to be integrated as seamlessly as possible into existing processes and tools. This was achieved for the current prototype, so that its call could be embedded directly into the modeling platform as a so-called “Innovator Java engineering action”. In this way, the execution of MoSt and the selection of the database objects for which the synthetic statistics are intended to be generated is entirely possible through Innovator's standard user interface. In addition to the procedural generation logic realized in MoSt, the prototype is supplemented by a UML profile, implemented analogously to FIG. 2, for the definition of PIs 301 in the data model (see FIG. 1). Analogously, an adaption of MoSt for deviating meta-models would also be conceivable without restricting the functionality.

Beyond minimal restrictions, all the functionalities, as described conceptually before and illustrated in FIG. 3 and FIG. 4, are implemented in MoSt. This means that MoSt can generate both “logical” and “physical” statistics (including distribution statistics), approximate non-specified optional PIs 301, read information that is missing in the data model from the DBMS catalog 303 and obtain PIs 301 through a reverse engineering. After the restrictions of MoSt that have been mentioned are concretized more closely below, details of the statistics generation for DB2 are explained, and the quality of the synthetic statistics that can be generated through MoSt, and also the overall idea of the invention based thereon, are evaluated. Due to the triviality of the reverse engineering in MoSt, further explanations of the implementation thereof are omitted.

Since MoSt is a prototype, its DB2 implementation is subject to certain restrictions. It is assumed that a tablespace corresponding to the IBM recommendations contains only precisely one table 200 and, if it is partitioned, uses table partitioning. A further rule is that partitions of partitioned objects are filled to the same degree and parameterized in the same way. Expression-based, sparse and extended indexes, along with table functions and edit procedures, are not taken into account in the statistics generation implemented at present in MoSt. The support of objects in association with the DB2-pureXML technology is also not yet provided so far. In total, the said restrictions are always special cases which, experience shows, make up a proportion of less than 1% of the DB2 objects in established DB2 infrastructures. The intended goal of the method described in the invention for the early identification of a large proportion of potential performance problems is thus not impaired.

DB2 calculates database statistics (by default) using the RUNSTATS utility, and stores them, as already explained, in tables in the DB2 catalog. The DBMS 303 here records more statistical data than are then used by the optimizer for preparing the execution plan and thus also by the explain mechanisms. Further explanations are restricted to statistics relevant to the execution plan.

FIG. 5 represents these statistics, or statistics columns, by name depending on their associated base objects, together with their tabular storage location. More detailed information on the meaning of the individual statistics columns can be found collected in the relevant IBM documentation or the further explanations at the respective location used. Statistics relating to objects not supported by MoSt are neglected in FIG. 5, and statistics on tablespaces on the basis of the assumed 1:1 mapping to tables 101 within the table block 500

For the synthetic generation of the database statistics illustrated in FIG. 5, MoSt also requires, in addition to the PIs 301 already described, diverse additional information about tables 101, columns 102 and indexes 103. Provided the meta-model used allows it, this information can either be present in structured form in the data model, or can be read from the DB2 catalog. FIG. 6 illustrates the required column information, and classifies this on the basis of the already-mentioned reasons for its absence from the data model (or its meta-model).

The information regarding the character encoding, which provides information about the DB2-internal format for the conversion of PIs 301 such as, for example, the individual value probabilities, is to be considered as potentially missing information (a). If said information is not specified on the model side, it can be determined by means of the ENCODING SCHEME column of the SYSTABLES 503 table.

In the context of MoSt, information regarding implicitly created objects (b) primarily relates to indexes 103 created by DB2 implicitly to support primary and unique key constraints. In order for it to be possible to generate synthetic statistics for this information as well, it is necessary on the one hand to determine information about the identifier thereof (CREATOR and NAME), the base table thereof (TBCREATOR and TBNAME) as well as the uniqueness rule thereof (UNIQUERULE) from the SYSINDEXES 509 table. On the other hand, the columns indexed by the indexes and their sequence must be determined on the basis of the columns COLNAME and COLSEQ of the SYSKEYS 600 table.

Features (c) that are deliberately not recorded represent the majority. In terms of the meta-model used (see FIG. 1) these features are missing information on indexes, index spaces and tablespaces, which is necessary for the generation of synthetic (“physical”) statistics. The relevant parameters for tablespaces can be found in the PGSIZE (page size), MAXROWS (max. number of rows per page), DSSIZE (file size) and PARTITIONS (number of partitions) columns of the SYSTABLESPACE 502 table, as well as the PCTFREE (free space per page in %) and FREEPAGE (number of data pages to be used until one page is left empty) columns of the SYSTABLEPART 601 table. Analogous information for index spaces is found in PGSIZE and PCTFREE in SYSINDEXES 509 and SYSINDEXPART 602.

In addition, the columns SPARSE and IX_EXTENSION_TYPE, for filtering out the objects not supported by MoSt, as well as CLUSTERING (cluster indicator) and CREATEDTS (time of creation), for determining the clustering index, are required from the SYSINDEXES 509 table for indexes. The clustering index is the index whose key is used by DB2 to attempt to store the pages of a table in physical order. If no index is explicitly defined as a clustering index, DB2 implicitly uses the first defined index of a table as a clustering index.

The generation, implemented in MoSt, of the DB2 statistics shown in FIG. 5 is based on three different methods, already shown in FIG. 4. Firstly, for the generation of “logical” statistics, all that is done is to transfer or derive the PI values into the respective columns. This applies to PI_Table.cardinality and PI_Column.cardinality, whose values are transferred in a simple manner into the CARDF column in the table block 500 (503 and 504) or the columns CARDF 508, COLCARD 507 and COLCARDF 506 in the column block 501. To a large extent the cardinality information for indexes 103 in the index block 502 FIRSTKEYCARDF and FULLKEYCARDF can be determined in a manner analogous to the above. FIRSTKEYCARDF corresponds to the cardinality of the first index key, and is therefore equivalent to the cardinality of the underlying column. FULLKEYCARDF describes the overall cardinality of the index, i.e. the number of different index entries. Since MoSt is unable to obtain any information relating to the correlation of columns from the PIs 301 used, it is assumed that column values are distributed independently of one another. It follows that FULLKEYCARDF can be calculated by means of the product of all the cardinalities of the key columns contained in the index.

The second method used involves calculations of “physical” statistics—distribution statistics are initially excluded—on the basis of specifications for memory space estimation published by IBM. With their aid, MoSt calculates the number of database pages required in SYSTABSTATS (NPAGES) 504, SYSTABLESPACE (NACTIVE) 505 and SYSTABLES (NPAGES and NPAGESF) 503 for tables 101 (see table block 500). In this way, the number of leaves (NLEAF) as well as the index height (NLEVELS), which are both stored in SYSINDEXES 509, are determined for indexes 103 (see index block 502). PI_Table.cardinality, PI_Column.cardinality, PI_Column.averageLength and a large proportion of the features identified by “(c)” in FIG. 6 are used as input for the calculations.

The third and last method is the transformation of special statistics—predominantly (“physical”) distribution statistics—which cannot be estimated either through simple transfer or through the calculation specifications published by IBM. This might include the calculation of DB2 statistics related to value distributions carried out on the basis of the PIs 301, or else the approximate estimation of the clustering rate of indexes.

Histograms are the most detailed form of statistics collection relating to value distributions in DB2. They are stored in the SYSCOLDIST 508 table, precisely one line being used for each histogram interval. In simple terms, this is composed of
the type “H” for histogram,
an interval number (QUANTILENO) starting with 1 and assigned in ascending order,
the lowest (LOWVALUE) and highest (HIGHVALUE) value in the quantile,
the cardinality, or the number of different values in the interval (CARDF), and
the proportion, in percent, of all table records that fall within the current quantile (FREQUENCYF).

In order to approximate these data, MoSt uses the indicators PI_Column.valueRange, PI_Column.frequencies, PI_Column.distribution and PI_Column.cardinality. With the aid of PI_Column.valueRange and PI_Column.frequencies, an expected value for the values of the column is first calculated. Then from this, and from the distribution defined by PI_Column.distribution, MoSt approximates a suitable distribution function, on the basis of which the interval data LOWVALUE, HIGHVALUE and FREQUENCYF of the histograms are calculated through an integral calculation. CARDF is then calculated for the intervals determined, on the basis of PI_Column.cardinality.

Individual value probabilities can also be synthesized in a similar manner to histograms by means of PI_Column.frequencies. A value (COLVALUE) and its probability (FREQUENCYF) are stored for this purpose in the SYSCOLDIST 508 table for each line. Finally, in connection with the value distribution, the generation of statistics for value ranges on the basis of PI_Column.valueRange is explained. Value range information is stored by DB2 through the second smallest (LOW2KEY) and second largest (HIGH2KEY) value in SYSCOLUMNS 506. Since, particularly in the continuous case, PI_Column.valueRange only gives a lower and an upper bound for the value range, MoSt simplifies at this point, and always uses the lowest and highest values for LOW2KEY and HIGH2KEY. While the similarly-named LOWKEY and HIGHKEY columns in SYSCOLSTATS 507 do store precisely the smallest and largest value, this is however only partition-dependent. Since, in accordance with the restrictions described, MoSt assumes equally filled partitions, and DB2 also follows the same assumption when lines are not present in SYSCOLSTATS 507, no explicit statistics information is generated by MoSt for this table.

A general aspect involved in the generation of DB2 statistics on value distributions is the necessity of data format conversions. The columns HIGHVALUE, LOWVALUE 508, HIGH2KEY, LOW2KEY 506, and HIGHKEY and LOWKEY 507 shown in FIG. 5 in column block 501 store statistical information on the highest and lowest values of a column. In order to be able to record information over multiple data types, these values are stored as a variable-length binary character string (VARCHAR FOR BIT DATA) in a proprietary format internal to DB2. Values defined in PI_Column.valueRange and PI_Column.frequencies must accordingly be converted, depending on their data type, during the generation of statistics. MoSt is able to carry out this conversion for all DB2 data types for which such statistics are recorded.

In DB2, the clustering rate of indexes 103 describes the proportion of lines within the table 101 belonging to the index 103 that are stored physically in the sequence of the index key. The approximation of this rate by MoSt is based on a division into two classes. Expressed simply, in the preparation of the execution plan, DB2 only differentiates between an index 103 with a high (>=0.8) or low (<0.8) clustering rate (CLUSTERRATIOF), which is stored in SYSINDEXES 509. The fact that MoSt assumes that column values are distributed independently of one another affects the approximated clustering rates of indexes 103 as follows. Both clustering indexes and indexes 103 which are the same in their leading key as the clustering index of their table 101, receive a perfect CLUSTERRATIOF of 1. It is thus assumed that table lines are indeed stored in the sequence that accords with their clustering index 103, and that this is maintained, for example through regular reorganizations. Conversely, all other indexes 103 receive a poor CLUSTERRATIOF of 0.1.

Yet more comprehensively than the clustering rate, the expected number of data pages to be read when traversing an index 103 (DATAREPEATFACTORF) also provides information on the physical arrangement of table lines with reference to this index 103. In contrast, however, to CLUSTERRATIOF, approximate benchmarks for this characteristic value cannot be defined, and MoSt therefore leaves the DATAREPEATFACTORF in SYSINDEXES 509 unchanged at −1 (undefined). The remaining CLUSTERING column in SYSINDEXES 509 is not, strictly speaking, a (dynamic) statistic, since, as already described, it only provides information as to whether an index 103 has been defined as a clustering index 103 or not. It is, accordingly, always filled, and does not need to be manipulated by MoSt.

The percentage statistical value relating to the current compression rate of a table (PCTROWCOMP) stored in SYSTABLES 503 has not yet been mentioned. Since no PI 301 is provided through which information relating to possible compression effects can be given, MoSt leaves the value of the PCTROWCOMP column at 0.

All of the statistics generations carried out by MoSt are summarized in FIG. 7. It shows visually the effect of the respective PIs 301 used by MoSt on the database statistics stored in tabular form in DB2. Individual statistics columns are not considered for the sake of clarity.

The TPC-DS benchmark 800 was used to evaluate the quality of synthetic database statistics generated by MoSt, and the procedure illustrated visually in FIG. 8 was applied. The starting point was formed by a database schema Dᵣₑₐₗ 801 converted into DB2, including suitable test data of the TPC-DS benchmark 800 that were inserted. For all the objects belonging to the schema Dᵣₑₐₗ 801, the RUNSTATS1 utility was then used to collect “real” database statistics on the basis of the recommendations of the IBM Infosphere Optim Query Workload Tuner

Statistics Advisor. In parallel with this, the same database schema was realized again in DB2 without test data as D_{synth} 802, and (base) statistics were prepared using RUNSTATS2 for the objects contained in it. A full reverse engineering of the database statistics from Dᵣₑₐₗ 801 was then performed by MoSt, so that the information of said statistics was extracted and reduced to the PIs 301 described in the invention. On the basis of these indicators, which would later have to be specified/reworked by designers/architects 300, synthetic statistics were now conversely able to be generated by MoSt, with which synthetic statistics the (base) statistics of D_{synth} 802 relating to the columns illustrated in FIG. 5 were updated.

For the actual evaluation, the calculation of all the execution plans was performed by the explain mechanism for the workload belonging to the Benchmark 800 on the basis both of the Dᵣₑₐₗ 801 database schema as well as of the D_{synth} 802 schema. The execution plans were then able to be compared with one another for each statement for Dᵣₑₐₗ 801 and D_{synth} 802 in respect of the CPU costs (in milliseconds) estimated by the optimizer that are required for processing and are particularly important in the DB2 environment. If it was found that the execution plans in this respect have a high similarity, then it could be deduced that there is also a high similarity between the underlying synthetic and “real” statistics. From this it can in turn be concluded that the synthetically generated statistics have high quality, whereby the concept described in the invention, and the implementation presented, would finally be confirmed.

In accordance with the procedure described, all 99 of the SQL statements (or statement templates) provided by the TPC-DS benchmark 800 were analyzed in respect of their execution plans, the CPU costs respectively for Dᵣₑₐₗ 801 and D_{synth} 802 contained in the plans were compared with one another, and their relative deviation was calculated. The SQL statements were then grouped into three classes in accordance with the measured deviations: 0%-1%, 1%-10% and >10%. FIG. 9 visually illustrates the classes in terms of the relative number of SQL statements contained therein. It can be seen here that 41% of the execution plans calculated on the basis of the synthetic statistics are almost identical in the estimated CPU costs necessary for processing to those that are based on “real” statistics. A further high proportion of 45% of the queries still has a very high similarity, with a deviation of up to 10%.

Experience shows that even changes of 10% in the cost estimates of execution plans are scarcely perceptible, if at all, during the execution of SQL statements, and are obscured by, for example, changing cache hit rates or a varying system load.

In accordance with to the above chain of causation, the quality of the database statistics generated by MoSt is therefore to be assessed as very good for the great proportion of 86% of the queries. This is further reinforced by the fact that the SQL statement complexity—measured by the processing steps necessary on the part of DB2—does not correlate with the deviations determined (correlation coefficient close to 0). The possibility of implementing the concept of synthetic statistics can thus be confirmed at this point. In a closer analysis of the 14% of SQL statements with deviations that are greater than 10%, it was noticed that data with very skewed distribution are processed here, in some cases correlating with one another. Since, however, the concept described in invention in its current form considers, for the sake of simplicity, neither correlation information nor finely granular distribution data, these sources of error are only natural. Being only a 14% proportion of the complex SQL statements of the TPC-DS Benchmark 800, they are, moreover, tolerable for the overall result.

In the age of cloud computing, mobility and big data, modern (database) applications are confronted with ever greater requirements. The spectrum here ranges from functional aspects through to non-functional requirements which include, above all, a high performance. Continuous quality assurance measures to satisfy these requirements are indispensable, and are a central component of agile software and database development. These also include explain mechanisms of relational DBMS established for the execution plan analysis of SQL statements. These can give estimates and predictions of the expected performance for handling SQL statements on the basis of statistics regarding the data stored in the database.

Particularly for (new) database applications or application modules without existing, representative data stocks, no statistics thus standardly exist. The present invention addresses this problem, and presents an approach to nevertheless being able to use the explain mechanisms for quality assurance even without the expensive generation of (test) data. The statistics required here are generated synthetically on the basis of PIs recorded in structured form in the data model. The invention furthermore describes how the approach was implemented by way of example for the DBMS IBM DB2 for z/OS, and shows, building on this implementation, that synthetic database statistics are of high quality when compared with “real” statistics.

### LIST OF REFERENCE SIGNS USED

100—Database

101—Table

102—Column

103—Index

104—Character encoding

105—Constraint

106—Data type

107—Foreign key

108—Primary key

109—Unique key

110—Schema

111—Column option

200—PI_Table

201—PI_Column

300—Designer/Architect

301—Performance indicator

302—Data model

303—Database management system

500—Table block

501—Column block

502—Index block

503—SYSIBM.SYSTABLES

504—SYSIBM.SYSTABSTATS

505—SYSIBM.SYSTABLESPACE

506—SYSIBM.SYSCOLUMNS

507—SYSIBM.SYSCOLSTATS

508—SYSIBM.SYSCOLDIST

509—SYSIBM.SYSINDEXES

600—SYSIBM.SYSKEYS

601—SYSIBM.SYSTABLEPART

602—SYSIBM.SYSINDEXPART

800—TPC-DS Benchmark

801—Database schema Dᵣₑₐₗ

802—Database schema D_{synth}

1. A method for the generation of synthetic database statistics on the basis of abstract application knowledge in the form of PIs (301), comprising the steps of
generation of logical statistics
calculation of physical statistics, making use of the physical design of the database management system (303).

2. The method according to claim 1, wherein physical design information to be made use of is determined on the basis of the (DB catalog in the) database management system (303) and/or on the basis of the data model (302).

3. The method according to claim 1, wherein the transformation to physical distribution statistics takes place on the basis of PIs (301).

4. The method according to claim 1, wherein the cardinality of a table (200) and/or the cardinality, the average length, the value range, the individual value probabilities and/or the distribution of a column (201) are PIs (301).

5. The method according to claim 1, wherein the PIs (301) can be recorded in the data model.

6. The method according to claim 5, wherein UML as from version 2.0 is used for data modeling, and PIs (301) are integrated through UML profiles into the meta-model.

7. The use of a method according to claim 1, wherein the execution plans are prepared on the basis of the synthetically generated database statistics.

8. The method according to claim 1, wherein with the inclusion of real data (whose quantity increases over time) and of real statistics prepared for them, the quality of the synthetic database statistics is continuously improved in regular cycles.
